(19) United States
(12) Patent Application Publication
(10) Pub. No.: US 2012/0226006 A1
(43) Pub. Date: Sep. 6, 2012

(54) NOVEL INITIATION METHOD FOR POLYMERIZING (METH)ACRYLATES

(75) Inventors: Friedrich Georg Schmidt, Haltern am See (DE); Emmanouil Spyrou, Schermbeck (DE); Simon Krause, Aschaffenburg (DE); Stefan Spange, Orlamuende (DE); Ingmar Polenz, Limbach (DE); Katja Hase, Zschopau (DE)

(73) Assignees: Evonik Roehm GmbH, Darmstadt (DE); Evonik Degusa GmbH, Essen (DE)

(21) Appl. No.: 13/509,401

(22) PCT Filed: Nov. 29, 2010
(86) PCT No.: PCT/EP2010/068363

§ 371 Date: May 11, 2012

(30) Foreign Application Priority Data
Dec. 21, 2009 (DE) 10 2009 055 061.5

(51) Int. Cl. C08F 10/00; C08F 2/12; C08F 2/04; C08F 2/02; C08F 20/12; C08F 12/08

(52) U.S. Cl. 526/205; 526/220; 526/204; 526/219.3

(57) ABSTRACT

The invention relates to a novel polymerization method for (meth)acrylates, wherein the polymerization is initiated by isocyanates and special bases having an imine structure. By means of said novel method that can be deliberately employed, even high-molecular-weight poly(meth)acrylates having in part a narrow molecular weight distribution can be produced. Furthermore, a wide variety of polymer architectures, such as block, star or comb polymers, are available using said novel polymerization method.

### FIELD OF THE INVENTION

The present invention relates to an innovative polymerization technique for (meth)acrylates, in which the polymerization is initiated by isocyanates and specific bases with imine structure. Using this new technique, which can also be used in a targeted way, it is possible to prepare even high molecular weight poly(meth)acrylates with in some cases a narrow molecular weight distribution. Furthermore, using this new polymerization technique, a wide variety of polymer architectures are available, such as block, star or comb polymers.

The (meth)acrylate notation here denotes not only methacrylate, such as, for example methyl methacrylate, ethyl methacrylate, etc., but also acrylate, such as, for example, methyl acrylate, ethyl acrylate, etc., and also mixtures of both.

### PRIOR ART

For the polymerization of (meth)acrylates there are a series of polymerization techniques known. Free-radical polymerization especially is of decisive significance industrially. In the form of bulk, solution, emulsion or suspension polymerization, it is widely used for the synthesis of poly(meth)acrylates for a very wide variety of applications. These include molding compounds, Plexiglass, film-forming binders, additives or components in adhesives or sealants, to list but a few. A disadvantage of free-radical polymerization, however, is that no influence can be exerted on the polymer architecture, that functionalization is possible only in a very nonspecific way, and that the polymers are obtained with broad molecular weight distributions. Poly(meth)acrylates with a high molecular weight and/or a narrow distribution are available, in contrast, by means of an anionic polymerization. Disadvantages of this polymerization technique, on the other hand, are the exacting requirements in terms of the process regime, in relation to moisture exclusion or temperature, for example, and the impossibility of realizing functional groups on the polymer chain. Similar comments apply in respect of the group transfer polymerization of methacrylates, which has to date been of only very minor significance.

Suitable living or controlled polymerization techniques, other than the anionic techniques, include modern techniques of controlled radical polymerization. Both the molecular weight and the molecular weight distribution are regulable. As a living polymerization, they also allow the targeted construction of polymer architectures such as, for example, random copolymers or else block copolymer structures.

One example is RAFT polymerization (reversible addition fragmentation chain transfer polymerization). The mechanism of RAFT polymerization is described in more detail in EP 0 910 587. Disadvantages of RAFT polymerization include in particular the limited synthesis options for short-chain poly(meth)acrylates or for hybrid systems, and the fact that sulfur groups remain in the polymer.

The NMP technique (nitroxide mediated polymerization), on the other hand, is of only very limited usefulness for the synthesis of poly(meth)acrylates. This technique has great disadvantages in terms of diverse functional groups and the controlled setting of the molecular weight.

The ATRP technique (atom transfer radical polymerization) was developed in the 1990s significantly by Prof. Matyjaszewski (Matyjaszewski et al., J. Am. Chem. Soc., 1995, 117, p. 5614; WO 97/18247; Science, 1996, 272, p. 866). ATRP yields narrowly distributed polymers in the molar mass range of Mₙ=10 000-120 000 g/mol. A particular disadvantage is the use of transition metal catalysts, especially copper catalysts, whose removal from the product is very laborious and/or incomplete. Furthermore, acid groups disrupt the polymerization, and so such functionalities cannot be realized directly by means of ATRP.

Okamoto et al. (J. of Pol. Sci.: Polymer Chemistry, 12, 1974, pp. 1135-1140) describe the initiation of an MMA polymerization using triethylamine and isocyanates. This system, however, leads only to yields of below 20%.

### Object

It is an object of the present invention to provide a new polymerization technique for the polymerization of (meth)acrylates.

A particular object is to provide a polymerization technique which can be used to prepare high molecular weight poly(meth)acrylates having optionally narrow molecular weight distributions in yields of more than 20%.

Another object, furthermore, is to provide a polymerization technique for (meth)acrylates which can be used variably and diversely and which does not leave disruptive residues of initiator or catalyst, such as transition metals, behind in the polymer.

Other objects, not explicitly stated, will become apparent from the overall context of the subsequent description, claims and examples.

### Achievement

The objects have been achieved by means of a very surprisingly found new initiation mechanism with which a polymerization of vinylic monomers M can be started. Vinylic monomers M in this context are monomers which have a carbon-carbon double bond. Generally speaking, monomers of this kind can be polymerized radically and/or anionically. In this new method, the polymerization of monomers M is initiated by the presence of a component A and a component B. Component A is an isocyanate or a carbodiimide. Component B is an organic base.

There are two preferred methods here for implementing the initiation. In one, component B is added to a mixture of component A and the vinylic monomer M. In the other, conversely, component A is added for initiation to a mixture of component B and the vinylic monomer M.

Component B is preferably a tertiary organic base, more preferably an organic base having a carbon-nitrogen double bond, or, alternatively, is a trithiocarbonate.

Bases having the following functional groups, in particular, are suitable for use in the initiation method of the invention: imines, oxazolines, isoxazolones, thiazolines, amidines, guanidines, carbodiimides, imidazoles or trithiocarbonates.

Imines are understood to be compounds containing a group (Rx)(Ry)C═N(Rz). In this formula the two groups on the carbon atom, Rx and Ry, and the one group on the nitrogen atom, Rz, are freely selectable, different to or identical to one another, and it is also possible for them to form one or more rings. Examples of such imines are 2-methylpyrroline (1), N-benzylidenemethylamine (BMA, (2)) or N-4-methoxybenzylideneaniline (3).

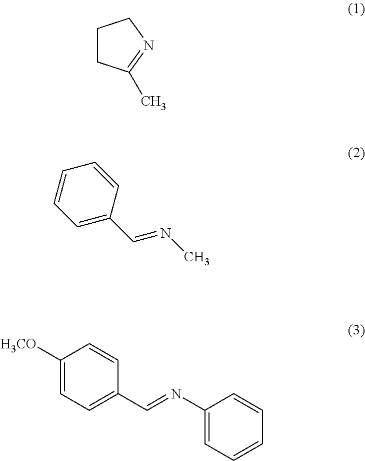

Oxazolines are compounds containing a group (Ry)O—C(Rx)=N(Rz). For these compounds as well, the groups on the carbon atom, Rx, on the oxygen, Ry, and on the nitrogen atom, Rz, are each freely selectable, different to or identical to one another, and it is also possible for them to form one or more rings. Examples of oxazolines are 2-ethyloxazoline (4) and 2-phenyloxazoline (5):

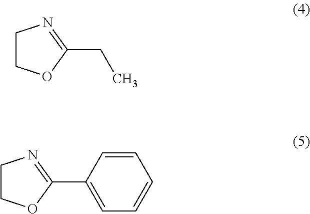

Isoxazolones are compounds featuring the structural element (6):

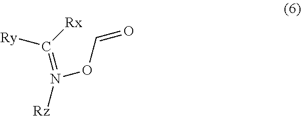

Again, for the two groups on the carbon atom, Rx and Ry, and the one group on the nitrogen atom, Rz, in the isoxazolones it is the case that they may be freely selectable and different to or identical to one another. It is also possible for them to form one or more rings. An example of an isoxazolone of this kind is 3-phenyl-5-isoxazolone (7):

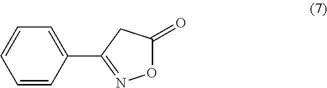

Thiazolines are compounds featuring the structural element (8) or (9):

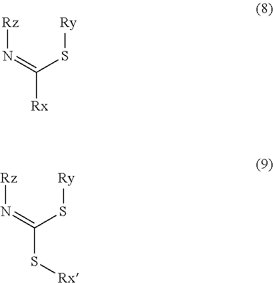

With regard to the groups on the carbon atom, Rx, on the sulfur atom, Ry, on the second sulfur atom, Rx′, and on the nitrogen atom, Rz, it is the case that they may be freely selectable and different to or identical to one another. It is also possible for them to form one or more rings. Examples of such thiazolines are 2-methylthiazoline (10) or 2-methyl-mercaptothiazoline (11):

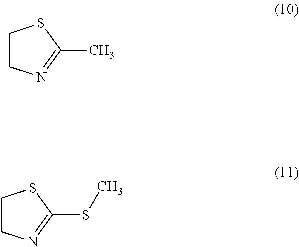

Amidines are compounds featuring the structural element (12), and guanidines are compounds featuring the structural element (13):

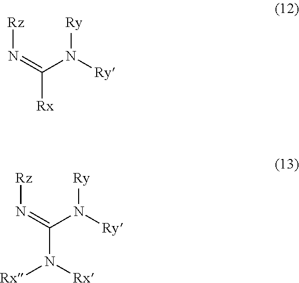

For the groups on the carbon atom, Rx, on the nitrogen atom, Rz, on the second nitrogen atom, Ry and Ry′, and on the third nitrogen atom, Rx′ and Rx″, it is the case that they may be freely selectable and different to or identical to one another. It is also possible for them to form one or more rings. Examples of amidines are 1,8-diazabicyclo[5.4.0]undec-7-ene (DBU, (14)), 1,5-diazabicyclo[4.3.0]non-5-ene (DBN, (15)) or N-(3-triethoxysilylpropyl)-4,5-dihydroimidazole (PDHI, (16)):

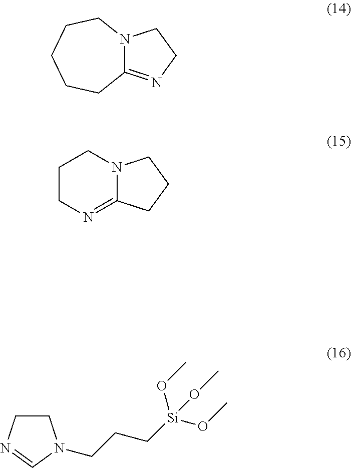

Examples of the guanidines are 7-methyl-1,5,7-triazabicyclo[4.4.0]dec-5-ene (MTBD, (17)), 1,1,3,3-tetramethylguanidine (TMG, (18)) or N-tert-butyl-1,1,3,3-tetramethylguanidine (19):

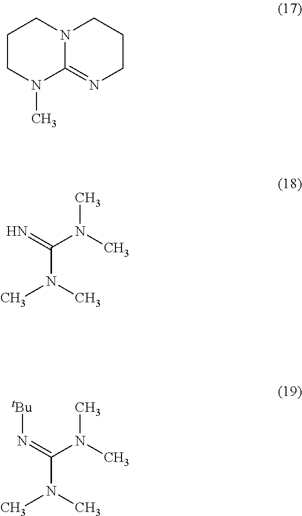

The group of the carbodiimides comprises compounds featuring the structural element (Rz)-N═C═N-(Rz′). For the groups on the nitrogen atoms, Rz and Rz′, it is the case that they may be freely selectable and different to or identical to one another. It is also possible for them to form one or more rings. An example of carbodiimides is diisopropylcarbodiimide (20):

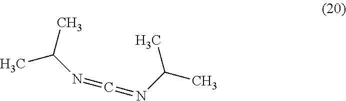

Compounds which can be used additionally may be imidazole (21) or 1-methylimidazole (22):

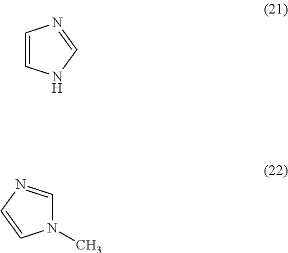

Examples of organic bases that can be used, without a C═N bond, are trithiocarbonates, featuring the structural element (23):

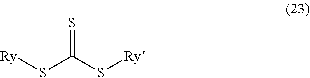

For the groups on the two sulfur atoms, Ry and Ry′, it is the case that they may be freely selectable and different to or identical to one another. It is also possible for them to form one or more rings. An example of trithiocarbonates is ethylidene trithiocarbonate (24):

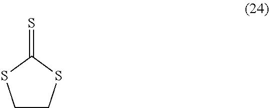

The examples of the organic bases do not have any capacity to restrict the invention in any form whatsoever. They serve, instead, to illustrate the multiplicity of compounds that can be used in accordance with the invention.

Component A comprises isocyanates, which may be singly, doubly or multiply functionalized. The wording “isocyanate” hereinafter also embraces the chemically equivalent thioisocyanates.

In one embodiment the further functionalities may comprise a second isocyanate group or further isocyanate groups. In another embodiment it is also possible for the further functionalities to be different functionalities which together with isocyanate groups form stable compounds.

Examples of monofunctional isocyanates are cyclohexyl isocyanate (25), phenyl isocyanate (26) and tert-butyl isocyanate (27). An example of a monofunctional thioisocyanate is phenyl thioisocyanate (28):

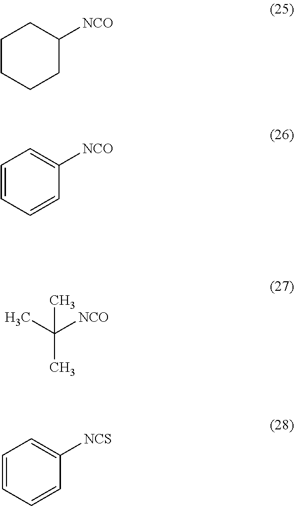

Examples of difunctional isocyanates, having two isocyanate groups, are hexamethylene 1,6-diisocyanate (HDI, (29)), toluene diisocyanate (TDI, (30)) and isophorone diisocyanate (IPDI, (31)):

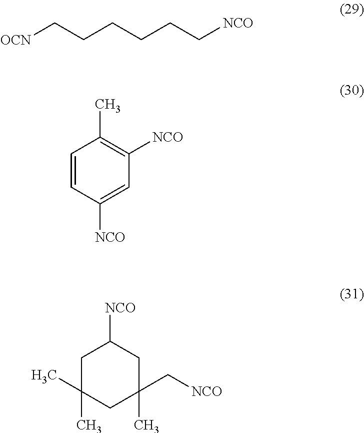

Further examples are condensates of these difunctional isocyanates, more particularly trimers of the isocyanates having two isocyanate groups such as the HDI trimer (32) or the IPDI trimer (33):

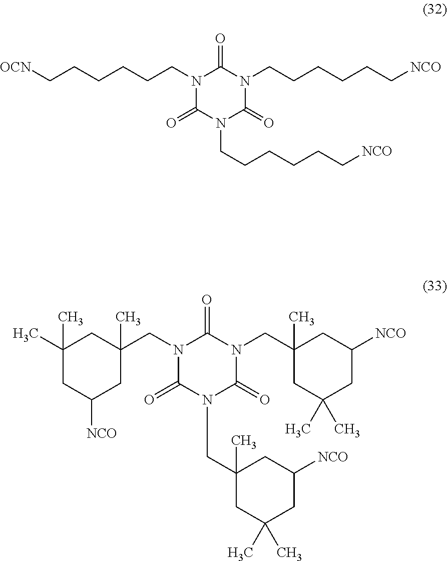

It is also possible, furthermore, to use monofunctional, linear isocyanates such as dodecyl isocyanate (34) or ethyl isocyanate (35):

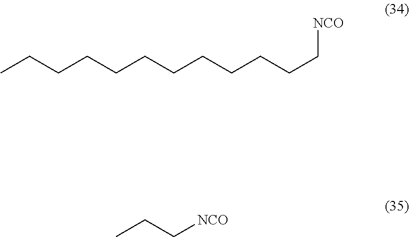

Alternatively to the isocyanates it is also possible to use carbodiimides. These are compounds featuring the structural element (Rz)-N═C═N-(Rz′), in accordance with the structure already outlined, as given for the organic bases that can be used. An example of a carbodiimide which can be used in place of isocyanates is diisopropylcarbodiimide (20):

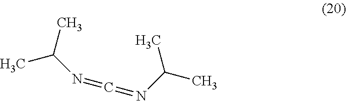

In one particular embodiment of the invention using carbodiimides, both components, A and B, may be identical. In this embodiment it is also not necessary for one of the two components to be added to the system with a time delay, and so, in this exceptional version, the initiator system is a one-component system.

In an alternative embodiment it is also possible for an adduct to be formed first from the two components, isocyanate and organic base, this adduct being able itself in turn to initiate a polymerization. Such intermediates can also be isolated, and so can be used as alternative initiators. An example of such an adduct is the reaction product (36) of two molecules of TMG (18) and HDI (29):

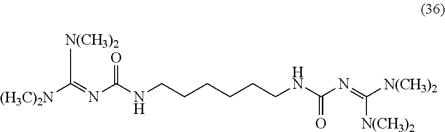

The method of the invention for initiating a polymerization is in principle independent of the polymerization method used. The method for initiation and the subsequent polymerization may be carried out, for example, in the form of a solution or bulk polymerization. The polymerization may be carried out in batch mode or continuously. The polymerization, furthermore, may be carried out over the entire customary temperature spectrum and under superatmospheric, atmospheric or subatmospheric pressure.

A particular aspect of the present invention is that the polymers obtained from the method are produced in a very broad molecular weight range. In a GPC measurement against a polystyrene standard, these polymers may have a molecular weight of between 1000 and 10 000 000 g/mol, more particularly between 5000 and 5 000 000 g/mol, and especially between 10 000 and 2 000 000 g/mol.

The vinylic monomers M are monomers which have a double bond, more particularly monomers having double bonds which are radically and/or anionically polymerizable. Such monomers are more particularly acrylates, methacrylates, styrene, styrene-derived monomers, α-olefins or mixtures of these monomers.

The (meth)acrylate notation stands hereinafter for alkyl esters of acrylic acid and/or of methacrylic acid.

In general the monomers are selected from the group of the alkyl (meth)acrylates of straight-chain, branched or cycloaliphatic alcohols having 1 to 40 C atoms, such as, for example, methyl (meth)acrylate, ethyl (meth)acrylate, n-butyl (meth)acrylate, isobutyl (meth) acrylate, tert-butyl (meth) acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates such as, for example, benzyl (meth)acrylate or phenyl (meth)acrylate, which may in each case be unsubstituted or have aryl radicals substituted 1-4 times; other aromatically substituted (meth)acrylates such as, for example, naphthyl (meth)acrylate; mono (meth)acrylates of ethers, polyethylene glycols, polypropylene glycols or mixtures thereof having 5-80 C atoms, such as, for example, tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate, and poly(propylene glycol) methyl ether (meth)acrylate, together.

Besides the (meth)acrylates set out above, it is also possible for further unsaturated monomers to be polymerized. Such monomers include, among others, 1-alkenes, such as 1-hexene, 1-heptene, branched alkenes such as, for example, vinylcyclohexane, 3,3-dimethyl-1-propene, 3-methyl-1-diisobutylene, 4-methyl-1-pentene, acrylonitrile, vinyl esters such as, for example, vinyl acetate, styrene, substituted styrenes having an alkyl substituent on the vinyl group, such as, for example, α-methylstyrene and α-ethylstyrene, substituted styrenes having one or more alkyl substituents on the ring, such as vinyltoluene and p-methylstyrene, heterocyclic compounds such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, 9-vinylcarbazole, 3-vinylcarbazole, 4-vinylcarbazole, 2-methyl-1-vinylimidazole, vinyloxolane, vinylfuran, vinylthiophene, vinylthiolane, vinylthiazoles, vinyloxazoles, and isoprenyl ethers. Other monomers are, for example, vinylpiperidine, 1-vinylimidazole, N-vinylpyrrolidone, 2-vinylpyrrolidone, N-vinylpyrrolidine, 3-vinylpyrrolidine, N-vinylcaprolactam, N-vinylbutyrolactam, hydrogenated vinylthiazoles, and hydrogenated vinyloxazoles.

The polymers prepared by the innovative method can be used in many fields of utility. Without wishing to restrict the invention in any form whatsoever with these examples, such fields include acrylic glass, molding compounds, raw materials for other injection-molding or extrusion applications, films, including mirror films, packaging films, and films for optical applications, laminates, laminate adhesives, foams, including sealing foams, foamed materials for packaging, synthetic fibers, composite materials, film-forming binders, coatings additives such as dispersing additives or particles for scratch-resistant coatings, primers, binders for adhesives, hotmelts, pressure-sensitive adhesives, reactive adhesives or sealants, heat-sealing varnishes, packaging materials, dental materials, bone cement, contact lenses, spectacle lenses, other lenses, in industrial applications, for example, traffic markings, floor coatings, plastisols, underbody coatings or insulations for vehicles, insulating materials, materials for use in pharmaceutical formulations, drug delivery matrices, oil additives such as flow improvers, polymer additives such as impact modifiers, compatibilizers or flow improvers, fiber spinning additives, particles in cosmetic applications, or as a raw material for producing porous molds.

### EXAMPLES

The weight-average molecular weights of the polymers from examples 1 to 38 were determined by means of GPC (gel permeation chromatography). The measurements were carried out with a PL-GPC 50 Plus from Polymer Laboratories Inc. at 40° C. in THF against a polystyrene standard. The measurement limit for M_{w} is situated at around 400 000 g/mol.

The weight-average molecular weights of the polymers from examples 43 to 48 were determined by means of GPC (gel permeation chromatography) in a method based on DIN 55672-1. The measurements were carried out with a GPC from Polymer Laboratories Inc. at an oven temperature of 35° C., in THF, with a run time of 48 minutes, and against a polystyrene standard. The measurement limit for M_{w} is situated at above 15 000 000 g/mol.

The yields were determined by weighing the isolated polymer after drying to constant weight in a vacuum drying cabinet at 60° C. and 20 mbar.

### General Procedure for Examples 1 to 21

2.5 g (2.65 mL, 25 mmol) of methyl methacrylate (MMA), the base (base used+molar ratio relative to the MMA: see table 1), and, optionally, a solvent (3 mL; see table) are introduced into a 25 mL round-bottom flask and stirred at 25° C. Accompanied by external cooling using an ice/sodium chloride mixture and by continuous stirring, the isocyanate (isocyanate used+molar ratio relative to the MMA: see table 1) is added to the flask. After a reaction time t (see table 1) with stirring and at 25° C., the mixture obtained is dissolved in 15 mL of chloroform and filtered. The solution is then purified by precipitation, by dropwise addition, from 300 mL of ice-cooled methanol. The PMMA is obtained as a white solid, and is isolated by filtration, washed three times with methanol, and dried to constant mass in a vacuum drying cabinet at 60° C. and 20 mbar. For results see table 1.

### General Procedure for Examples 22 to 27

2.5 g (2.65 mL, 25 mmol) of methyl methacrylate (MMA) and the base (base used+molar ratio relative to the MMA: see table 1) are introduced into a 25 mL round-bottom flask and stirred at 25° C. The solution is admixed with the isocyanate (isocyanate used+molar ratio relative to the MMA: see table 2) and heated under reflux. This corresponds in general to a solution temperature of 90° C. After a time t (see table 2) of stirring at the boiling point of the solution, there is an increasing rise in viscosity. The solution is cooled, the viscous oil is dissolved in 10 ml of chloroform and precipitated, by dropwise addition, from 300 mL of ice-cooled n-hexane, and the solid obtained is isolated by filtration. The PMMA obtained is washed repeatedly with n-hexane and dried to constant mass in a vacuum drying cabinet at 60° C. and 20 mbar.

n-Hexane can be distilled off from the precipitation filtrate, and the resultant residue used again for the polymerization. With this type of work-up, a loss of mass of 5% to 27% for the base/isocyanate system can be expected. For results see table 2.

### General Procedure for Examples 28 to 32

The base (base used+molar ratio relative to the MMA: see table 3) is dissolved in 3 mL of CHCl₃ in a 25 mL round-bottom flask. The solution is admixed with 2.5 g (2.65 mL, 25 mmol) of MMA and the isocyanate (isocyanate used+molar ratio relative to the MMA: see table 3) and heated under reflux. This corresponds in general to a solution temperature of 90° C. After a time t (see table 3) of stirring at the boiling point of the solution, there is an increasing rise in viscosity. The solution is cooled, the viscous oil is dissolved in 10 ml of chloroform and precipitated, by dropwise addition, from 300 mL of ice-cooled n-hexane, and the solid obtained is isolated by filtration. The PMMA obtained is washed repeatedly with n-hexane and dried to constant mass in a vacuum drying cabinet at 60° C. and 20 mbar.

n-Hexane can be distilled off from the precipitation filtrate, and the resultant residue used again for the polymerization. With this type of work-up, a loss of mass of 5% to 27% for the base/isocyanate system can be expected. For results see table 3.

### General Procedure for Examples 33 to 36 and for Comparative Examples C1 to C4

Mixture A (for composition see table 4) is introduced into a 25 mL round-bottom flask and stirred at 25° C. Accompanied by external cooling using an ice/sodium chloride mixture and by continuous stirring, the mixture B is added to the flask. After 18 hours with stirring at 25° C., the mixture obtained is dissolved in 15 mL of chloroform and filtered. The solution is then purified by precipitation, by dropwise addition, from 300 mL of ice-cooled methanol. The PMMA formed is obtained as a white solid, and is isolated by filtration, washed three times with methanol, and dried to constant mass in a vacuum drying cabinet at 60° C. and 20 mbar. This white solid can only be PMMA. Verification is made by means of ¹H-NMR spectroscopy. The presence of PMMA is evidence of polymerization having taken place. Separate characterization of the polymers obtained was not carried out in this case.

Examples 39 to 42 and comparative examples C1 to C4 each use 2.5 g (2.65 mL, 25 mmol) of methyl methacrylate. This corresponds to 6 molar equivalents, and on this basis, in each case, 1 molar equivalent of hexamethylene diisocyanate (HDI, 29) and 1 molar equivalent of 1,1,3,3-tetramethylguanidine (TMG, 18) or 1,8-diazabicyclo[5.4.0]undec-7-ene (DBU, 14) are used. For results see table 4.

### General Procedure for Examples 37 to 42

2.5 g (2.65 mL, 25 mmol) of methyl methacrylate (MMA) and 1,1,3,3-tetramethylguanidine (TMG, (18), molar ratio relative to the MMA: see table 5) are introduced into a 25 mL round-bottom flask and stirred at 25° C. Accompanied by external cooling with an ice/sodium chloride mixture and by continuous stirring, hexamethylene 1,6-diisocyanate (HDI, (29), molar ratio relative to the MMA: see table 5) is added to the flask. After 7 days with stirring at 25° C., the mixture obtained is dissolved in 15 mL of chloroform and filtered. The solution is subsequently purified by precipitation, by dropwise addition, from 300 mL of ice-cooled hexane. The PMMA is obtained as a white solid, and is isolated by filtration, washed three times with hexane, and dried to constant mass in a vacuum drying cabinet at 60° C. and 20 mbar. For results see table 5.

TABLE 1

| | | | MMA/ | | | | Yield |
|---|---|---|---|---|---|---|---|
| | | | Base/ | | | | of |
| | | Iso- | Iso- | t | Solvent/ | M_{w} | PMMA |
| Ex. | Base | cyanate | cyanate | [h] | c_{MMA} [mol/L] | [g/mol] | [%] |
| 1 | (14) | (29) | 6/1/1 | 18 | CHCl₃/2.80 | 112 900 | 69 |
| 2 | | (35) | 2/1/1 | 18 | bulk | 267 000 | 53 |
| 3 | | (34) | 6/1/1 | 48 | bulk | 209 000 | 51 |
| 4 | | (25) | 6/1/1 | 18 | bulk | 141 000 | 28 |
| 5 | (15) | (29) | 6/1/1 | 34 | CHCl₃/2.83 | >400 000 | 60 |
| 6 | | (34) | 6/1/1 | 48 | bulk | >400 000 | 73 |
| 7 | (18) | (25) | 2/1/1 | 18 | bulk | n.d. | 56 |
| 8 | | (29) | 2/2/1 | 18 | bulk | n.d. | 89 |
| 9 | (19) | (29) | 1/1/1 | 18 | bulk | >400 000 | 30 |
| 10 | | (25) | 1/1/2 | 18 | bulk | 13 000 | 24 |
| 11 | (17) | (29) | 6/1/1 | 18 | bulk | 66 000 | 64 |
| 12 | (1) | (29) | 2/1/1 | 18 | bulk | 79 000 | 80 |
| 13 | | (35) | 6/1/2 | 18 | bulk | 106 000 | 29 |
| 14 | (10) | (29) | 2/1/1 | 20 | bulk | 161 000 | 25 |
| 15 | (11) | (29) | 2/1/1 | 18 | bulk | 107 000 | 100 |
| 16 | | | 6/1/1 | 18 | bulk | 203 000 | 82 |
| 17 | | | 25/1/1 | 18 | bulk | >400 000 | 73 |
| 18 | | | 3/1/1 | 62 | hexane/2.02 | 63 000 | 83 |
| 19 | (7) | (29) | 6/1/1 | 67 | CHCl₃/3.00 | 113 100 | 65 |
| 20 | | | 6/1/1 | 20 | THF/2.21 | 77 800 | 57 |
| 21 | (22) | (29) | 2/1/1 | 24 | bulk | 229 000 | 58 |

TABLE 2

| | | | MMA/Base/ | t | M_{w} | Yield of |
|---|---|---|---|---|---|---|
| Ex. | Base | Isocyanate | Isocyanate | [h] | [g/mol] | PMMA [%] |
| 22 | (2) | (29) | 2/1/1 | 6 | 167 000 | 69 |
| 23 | (3) | (29) | 6/1/1 | 6 | 229 000 | 47 |
| 24 | (4) | (29) | 2/1/1 | 6 | 88 000 | 74 |
| 25 | | (26) | 2/1/1 | 6 | >400 000 | 23 |
| 26 | (20) | (29) | 2/1/1 | 3 | 63 000 | 77 |
| 27 | | — | 2/1 | 30 | 19 000 | 12 |

TABLE 3

| | | | MMA/ | | | | Yield |
|---|---|---|---|---|---|---|---|
| | | | Base/ | | Solvent/ | | of |
| | | Iso- | Iso- | t | c_{MMA} | M_{w} | PMMA |
| Ex. | Base | cyanate | cyanate | [h] | [mol/L] | [g/mol] | [%] |
| 28 | (2) | (29) | 6/1/1 | 25 | CHCl₃/3.66 | n.d. | 23 |
| 29 | (5) | (29) | 6/1/1 | 10 | CHCl₃/2.82 | >400 000 | 75 |
| 30 | | (26) | 6/1/1 | 10 | CHCl₃/3.76 | >400 000 | 46 |
| 31 | (24) | (26) | 2/1/1 | 54 | CHCl₃/2.60 | >400 000 | 18 |
| 32 | (22) | (29) | 2/1/1 | 71 | CHCl₃/2.66 | n.d. | 24 |

TABLE 4

| | | | Polymer- |
|---|---|---|---|
| Example | Mixture A | Mixture B | ization |
| C1 | HDI (29)/MMA | — | no |
| C2 | DBU (14)/MMA | — | no |
| C3 | DBU (14)/HDI (29) | MMA | no |
| 33 | DBU (14)/MMA | HDI (29) | yes |
| 34 | MMA/HDI (29) | DBU (14) | yes |
| C4 | TMG (18)/HDI (29) | MMA | no |
| 35 | TMG (18)/MMA | HDI (29) | yes |
| 36 | MMA/HDI (29) | TMG (18) | yes |

TABLE 5

| | MMA/TGM | M_{w} |
|---|---|---|
| Example | (18)/HDI (29) | [g/mol] |
| 37 | 2/1/1 | 1 170 000 |
| 38 | 6/1/1 | 2 940 000 |
| 39 | 10/1/1 | 2 270 000 |
| 40 | 14/1/1 | 2 670 000 |
| 41 | 20/1/1 | 2 530 000 |
| 42 | 40/1/1 | 4 220 000 |

Examples 1 to 25 in table 1 show that the components A and B of the invention can be used diversely, in some cases even just at room temperature, in solution or in bulk, as initiators for methacrylates.

Examples 26 to 32 (table 2) in turn show combinations of components A and B which can be used as initiators in bulk at relatively high temperatures. Examples 33 to 38 (table 3), accordingly, show combinations in solution at relatively high temperatures.

Example 20 here is a system where components A and B comprise an identical carbodiimide, which is added in one batch. In examples 23 and 24 a trithiocarbonate was used as base.

Examples 39 to 42 (table 4) show that the method of the invention for initiating a polymerization operates in those cases where the monomer and component A or B are introduced initially and the other component in each case is added subsequently. The initiation does not operate if either component A (comparative example C2) or component B (comparative example C1) is missing. The initiation also does not always operate if components A and B are introduced initially and the monomer or monomers is or are added to this mixture (comparative examples C3 and C4). An exception to this, for example, is the initiation from example 32.

Examples 43 to 48 are capable of verifying that particularly high molecular weights in particular can be realized with the method of the invention.

1: A method for initiating a polymerization, the method comprising:
(I) adding (A) a first component comprising an isocyanate or a carbodiimide and (B) a second component comprising an organic base to a vinylic monomer (M), thereby initiating the polymerization of the monomer (M),
wherein the first component (A) and the second component (B) are added separately to the monomer (M).

2: The method of claim 1, wherein the adding comprises:
(Ia) adding the first component (A) to the vinylic monomer (M), to obtain a mixture; and then
(Ib) adding the second component (B) to the mixture.

3: The method of claim 1, wherein the adding comprises:
(Ia′) adding the second component (B) to the vinylic monomer (M), to obtain a mixture; and then
(Ib′) adding the first component (A) to the mixture.

4: The method of claim 1, wherein the first component (A) comprises dodecyl isocyanate, ethyl isocyanate, hexamethylene 1,6-diisocyanate (HDI), an HDI trimer, cyclohexyl isocyanate, tert-butyl isocyanate, phenyl isocyanate, toluene diisocyanate (TDI), isophorone diisocyanate (IPDI), or an IPDI trimer.

5: The method of claim 1, wherein the second component (B) comprises a tertiary organic base or a trithiocarbonate.

6: The method of claim 5, wherein the organic base is an imine.

7: The method of claim 5, wherein the organic base is an oxazoline or an isoxazolone.

8: The method of claim 5, wherein the organic base is a thiazoline.

9: The method of claim 5, wherein the organic base is an amidine or a guanidine.

10: The method of claim 5, wherein the organic base is a carbodiimide.

11: The method of claim 5, wherein the organic base is an imidazole.

12: The method of claim 1, wherein the polymerization is carried out as a solution polymerization, a bulk polymerization, an emulsion polymerization, a suspension polymerization, a miniemulsion polymerization or a microemulsion polymerization.

13: The method of claim 1, wherein the isocyanate is a difunctional isocyanate.

14: The method of claim 1, wherein a polymer obtained from the method, in a GPC measurement against a polystyrene standard, has a weight-average molecular weight of between 5000 and 10 000 000 g/mol.

15: The method of claim 1, wherein the vinylic monomer (M) is at least one selected from the group consisting of an acrylate, a methacrylate, styrene, a styrene-derived monomer, and an α-olefin.

16: A method for initiating a polymerization, the method comprising:
contacting a carbodiimide with a vinylic monomer (M), thereby initiating the polymerization of the monomer (M).

17: The method of claim 16, wherein a polymer obtained from the method, in a GPC measurement against a polystyrene standard, has a molecular weight of between 5000 and 10 000 000 g/mol.

18: The method of claim 16, wherein the vinylic monomer (M) is at least one selected from the group consisting of an acrylate, a methacrylate, styrene, a styrene-derived monomer, and an α-olefin.

19: The method of claim 1, wherein the second component (B) comprises a tertiary organic base comprising a carbon-nitrogen double bond.

20: The method of claim 1, wherein the second component (B) comprises a trithiocarbonate.
